(19) United States
(12) Patent Application Publication
(10) Pub. No.: US 2008/0218055 A1
(43) Pub. Date: Sep. 11, 2008

(54) Lightweight High Deflection Angle Cathode Ray Tube and Method of Making the Same

(76) Inventors: James John Maley, Lancaster, PA (US); Doreen May Fulmer, Lancaster, PA (US); Jennifer Leigh Dimeler, Elizabethtown, PA (US); James Francis Edwards, Lancaster, PA (US)

Correspondence Address: Joseph J. Laks;Thomson Licensing LLC, 2 Independence Way, Patent Operations, PO Box 5312, PRINCETON, NJ, 08543, US

(21) Appl. No.: 10/589,651

(22) PCT Filed: Oct. 22, 2004
(86) PCT No.: PCT/US2004/032503

§ 371 Date: Aug. 16, 2006

Related U.S. Application Data
(60) Provisional application No. 60/551,588, filed on Mar. 9, 2004.

(51) Int. Cl. H01J 29/88

(52) U.S. Cl. 313/479

(57) ABSTRACT

A cathode ray tube has an envelope (2) including a panel (3) and a neck (4) connected by a funnel (5). The funnel comprises a main body portion (16) having a seal edge (17) and a neck. The main body portion has at least one region with a higher tensile stress than other regions of the main body portion. An exterior surface of the main body portion has first and second protective coatings (20, 21). The first protective coating (20) covers at least a portion of the at least one region. The first protective coating is of a composition and thickness such that the first protective coating substantially reduces the susceptibility of the at least one region from incurring mechanical damage. The second protective coating (21) covers at least a portion of the first protective coating and is of a composition and thickness such that the second protective coating protects the funnel from moisture contact.

### CROSS-REFERENCE TO RELATED APPLICATIONS

This application claims the benefit of U.S. Provisional Patent Application Ser. No. 60/551,588, entitled “Lightweight, High Deflection Angle Cathode Ray Tube and Method of Making the Same” and filed Mar. 9, 2004, which is incorporated by reference herein in its entirety.

### FIELD OF THE INVENTION

The invention relates to cathode ray tubes and, more particularly, to a cathode ray tube having a glass funnel with a first protective coating on an external surface thereof for preventing mechanical damage to the funnel in regions of high tensile stress and a second protective coating on an external surface thereof for protecting the funnel from moisture contact. The invention further relates to a method for making the same.

### BACKGROUND OF THE INVENTION

As new types of image display devices, such as non-cathode ray tube flat panel displays, continue to be introduced into the marketplace, there is an increased demand to reduce the depth of conventional cathode ray tubes (CRTs) to remain competitive with the non-cathode ray tube flat panel displays. Because the depth of the CRT is largely determined by the depth of a glass funnel that forms the CRT, it is necessary to shorten the funnel to provide the CRT with a reduced depth. Shortening the funnel of the CRT requires increasing the deflection angle of the funnel. As the deflection angle of the funnel is increased, however, the tensile stress on the funnel is also increased. The typical deflection angle of a reduced depth CRT is about 125-135 degrees.

Funnels having regions with tensile stress above 1350 PSI are considered unsafe, because the funnel has a higher probability of mechanical failure if the funnel is exposed to moisture or incurs mechanical damage, such as a surface defect, scratch, ding, check, etc. In order to decrease the probability of mechanical failure, it is known to decrease the tensile stress on the funnel to 1350 PSI by increasing the glass thickness of the funnel. Increasing the glass thickness of the funnel, however, also increases the weight and cost of the CRT. For example, as shown in FIG. 4, when the tensile stress on the funnel is maintained at a maximum of 1350 PSI and the deflection angle of the funnel is increased from 104 degrees to 118 degrees, the weight of the funnel increases by about 3 kilograms. Additionally, when the tensile stress on the funnel is maintained at a maximum of 1350 PSI and the deflection angle of the funnel is increased from 104 degrees to 130 degrees, the weight of the funnel increases by about 10.5 kilograms.

It would therefore be desirable to develop a CRT that can safely operate when the funnel has regions of tensile stress above 1350 PSI so that the glass thickness of the funnel does not have to be increased to prevent mechanical failure.

### SUMMARY OF THE INVENTION

The invention relates to a cathode ray tube having an envelope including a panel and a neck connected by a funnel. The funnel comprises a main body portion having a seal edge and a neck. The main body portion has at least one region with a higher tensile stress than other regions of the main body portion. An exterior surface of the main body portion has first and second protective coatings. The first protective coating covers at least a portion of the at least one region with the higher tensile stress. The first protective coating is of a composition and thickness such that the first protective coating substantially reduces the susceptibility of the at least one region from incurring mechanical damage. The second protective coating covers at least a portion of the first protective coating and is of a composition and thickness such that the second protective coating protects the funnel from moisture contact.

### BRIEF DESCRIPTION OF THE DRAWINGS

The invention will now be described by way of example with reference to the accompanying drawings.

FIG. 1 is a cross sectional view of a CRT.

FIG. 2 is a top view of a funnel of the CRT.

FIG. 3 is rear partial sectional view of the funnel of FIG. 2.

FIG. 4 is a graph illustrating how the weight of the funnel generally increases as the deflection angle of the funnel increases when the funnel is maintained at a given tensile stress.

### DETAILED DESCRIPTION OF THE INVENTION

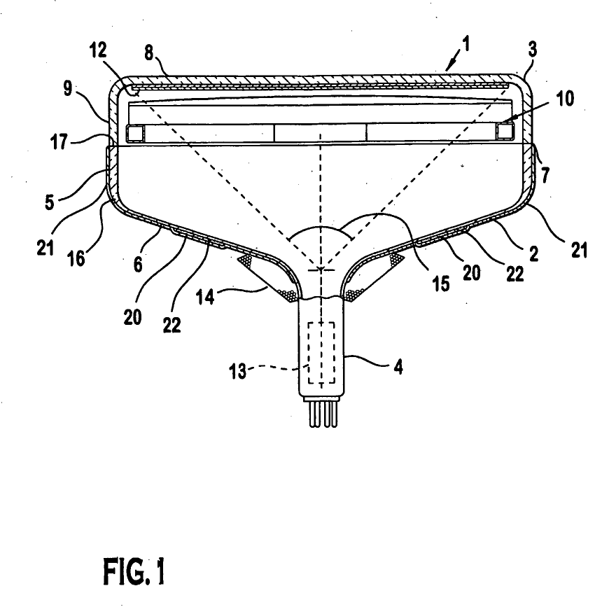

FIG. 1 shows a CRT 1 having a glass envelope 2. The glass envelope 2 includes a rectangular faceplate panel 3 and a tubular neck 4 connected by a funnel 5. The funnel 5 has a deflection angle 15 and an internal conductive coating (not shown) that extends from an anode button 6 toward the faceplate panel 3 and to the neck 4. The faceplate panel 3 consists of a viewing faceplate 8 and a peripheral flange or sidewall 9, which is sealed to the funnel 5 by a glass frit 7. A phosphor screen 12 is carried by an inner surface of the faceplate panel 3. The screen 12 can be a line screen with phosphor lines arranged in triads, wherein each of the triads includes three phosphor lines.

A mask frame assembly 10 is removably mounted in predetermined spaced relation to the screen 12. An electron gun 13, shown schematically by dashed lines in FIG. 1, is centrally mounted within the neck 4. The electron gun 13 can generate and direct three inline electron beams, a center beam and two side or outer beams, along convergent paths through the mask frame assembly 10 to the screen 12. The CRT 1 is designed to be used with an external magnetic deflection yoke 14 shown in a neighborhood of the funnel-to-neck junction. When activated, the yoke 14 subjects the three beams to magnetic fields that cause the beams to scan horizontally and vertically in a rectangular raster over the screen 12.

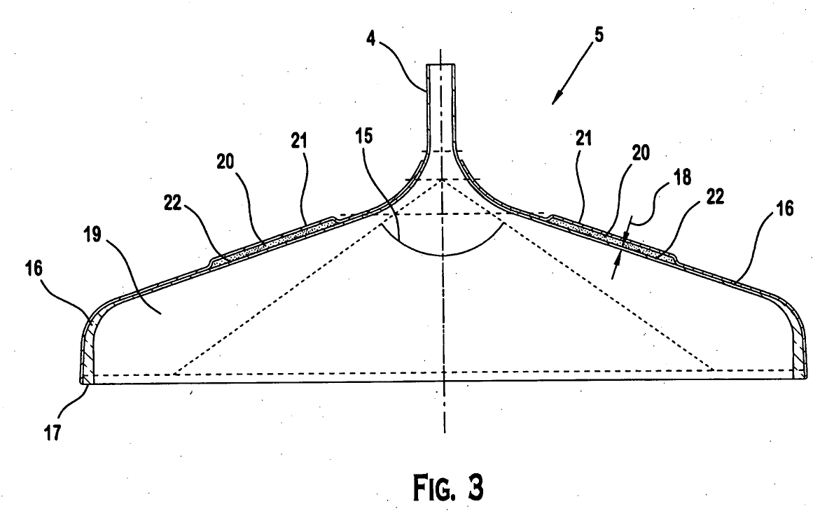

The funnel 5 will now be described in greater detail. As shown in FIG. 3, the funnel 5 includes a main body portion 16 having a seal edge 17 and a neck 4. The funnel 5 has a deflection angle 15. In the illustrated embodiment, the deflection angle 15 is about 125-135 degrees. The deflection angle 15, however, may vary depending on the desired dimensions of the funnel 5. The main body portion 16 has a glass thickness 18 and regions 22 that have a higher tensile stress than other regions of the main body portion 16. For example, the regions 22 may be the regions that have a tensile stress above 1350 PSI. Although the main body portion 16 is illustrated as having four of the regions 22, the number and dimensions of the regions 22 will vary depending on the thickness 18 and deflection angle 15 of the desired funnel 5.

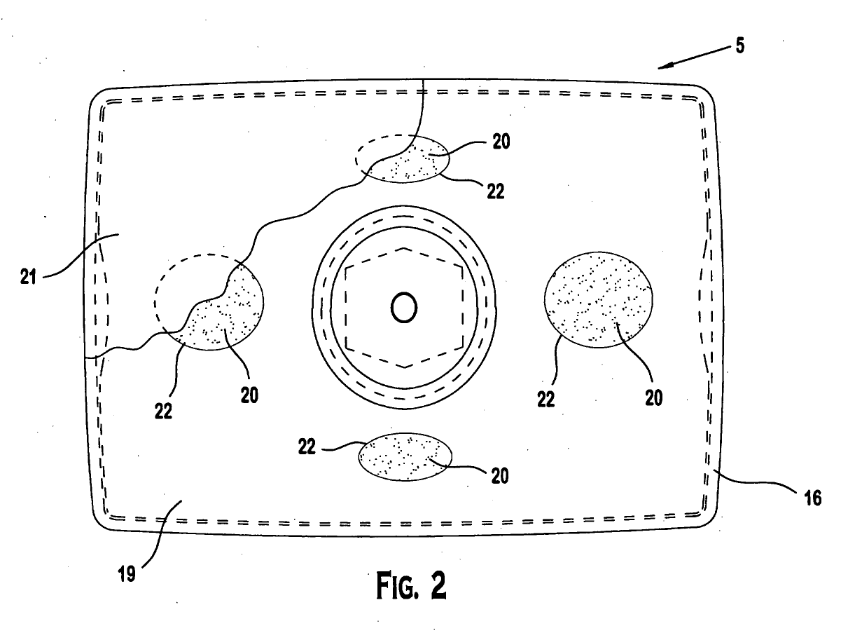

As shown in FIGS. 2-3, the main body portion 16 has a first protective coating 20 on an external surface 19 thereof. The first protective coating 20 covers at least a portion of the regions 22. The first protective coating 20 is of a composition and thickness such that the first protective coating 20 substantially reduces the susceptibility of the regions 22 from incurring mechanical damage, such as a surface defect, scratch, ding, check, etc. The first protective coating 20 should also be made to be capable of withstanding CRT processing temperatures, to be discussed later. The first protective coating 20 may be, for example, a silicate layer containing inorganic fillers. The silicate layer may be, for example, a potassium silicate layer, a lithium silicate layer, or a sodium silicate layer, and the inorganic fillers may be, for example, an aluminum oxide, a silicon carbide, a boron carbide, or a titanium carbide.

As shown in FIG. 2-3, a second protective coating 21 covers the first protective coating 20. The second protective coating 21 can substantially cover the main body portion 16 and extend from proximate the neck 4 to the seal edge 17. The second protective coating 21 is of a composition and thickness such that the second protective coating 21 protects the funnel 5 from moisture contact. The second protective coating 21 may be, for example, a poly-tetrafluoroethylene (TEFLON®) or silicone layer containing graphite. Although the second protective coating 21 is illustrated as substantially covering the main body portion 16 and the first protective coating 20, the second protective coating 21 may cover only a portion of the main body portion 16 or the first protective coating 20 depending on the desired moisture protection and CRT capacitance.

The method of manufacturing the CRT 1 will now be described in greater detail. The first protective coating 20 is applied to the external surface 19 of the funnel 5 such that the first protective coating 20 covers at least a portion of the regions 22. The first protective coating 20 may be applied using any conventional coating methods, for example, by spraying, brushing, roller coating, etc.

The faceplate panel 3, having a screen 12 and the mask support frame assembly 10, is aligned with the funnel 5 and sealed to the seal edge 17 of the funnel 5 at the peripheral sidewall 9 by melting the glass frit 7. The electron gun 13 is aligned and permanently mounted in the neck 4 of the funnel 5 using known methods. The envelope 2 is evacuated and hermetically sealed to form the CRT 1 using known methods.

The second protective coating 21 is then applied to the external surface 19 of the funnel 5 such that the second protective coating 21 covers the first protective coating 20. The second protective coating is applied such that it substantially covers the main body portion 16 or covers a majority of the main body portion 16 and extends from the neck 4 to the seal edge 17. The second protective coating 21 may be applied using any conventional coating methods, for example, by spraying, brushing, roller coating, etc.

Although the first protective coating 20 is taught as being applied to the funnel 5 before sealing the funnel 5 to the faceplate panel 3, such that the first protective coating 20 is subject to CRT processing temperatures, the first protective coating 20 may alternatively be applied at any stage during the manufacture of the CRT 1.

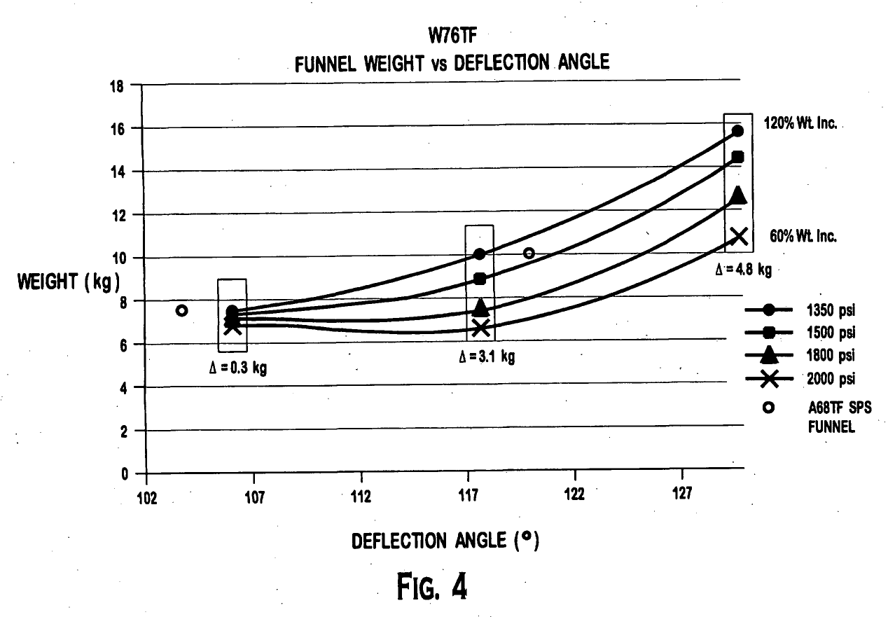

The first protective coating 20 protects the external surface 19 of the funnel 5 in the regions 22 of high tensile stress from mechanical damage, because the first protective coating 20 incurs and/or prevents mechanical damage that would otherwise occur on the funnel 5. The second protective coating 21 further protects the external surface 19 of the funnel 5 from being exposed to moisture. The funnel 5, therefore, has a lower probability of mechanical failure in the regions 22 of higher tensile stress. Because there is a lower probability of mechanical failure in the regions 22 of higher tensile stress, the funnel 5 can be manufactured with regions of higher tensile stress and a low glass thickness 18. Additionally, the funnel 5 can safely operate when the regions 22 have a tensile stress above 1350 PSI without having to increase the glass thickness 18 of the funnel 5. In this way, the weight of the CRT 1 can be kept at a minimum, which benefits manufacturing yields and lowers costs. For example, as shown in FIG. 4, when the tensile stress on the funnel is maintained at a maximum of 2000 PSI and the deflection angle of the funnel is increased from 104 degrees to 118 degrees, the weight of the funnel can be reduced by about 3.1 kilograms. Additionally, when the tensile stress on the funnel is maintained at a maximum of 2000 PSI and the deflection angle of the funnel is increased from 104 degrees to 130 degrees, the weight of the funnel can be reduced by about 4.8 kilograms.

The foregoing illustrates some of the possibilities for practicing the invention. Many other embodiments are possible within the scope and spirit of the invention. Additional embodiments of the invention include the feature of the CRT being a transposed scanning CRT, wherein the electron emitting cathodes are coplanar and oriented vertically and the electron beams emitted from the cathodes are scanned vertically. Other features include scenarios where only the first protective coating 20 is applied to at least a portion of the regions 22 of the funnel 5. It is, therefore, intended that the foregoing description be regarded as illustrative rather than limiting, and that the scope of the invention is given by the appended claims together with their full range of equivalents.

What is claimed is:

1. A cathode ray tube having an envelope including a panel and a neck connected by a funnel, the funnel comprising:
a main body portion having a seal edge and a neck, the main body portion having at least one region with a higher tensile stress than other regions of the main body portion;
a first protective coating on an exterior surface of the main body portion, the first protective coating covering at least a portion of the at least one region, the first protective coating being of a composition and thickness to substantially reduce susceptibility of the at least one region to mechanical damage; and
a second protective coating on the exterior surface of the main body portion that covers at least a portion of the first protective coating, the second protective coating being of a composition and thickness to protect the funnel from moisture contact.

2. The cathode ray tube of claim 1, wherein the first protective coating is a silicate layer.

3. The cathode ray tube of claim 2, wherein the silicate layer contains aluminum oxide, silicon carbide, titanium carbide, or boron carbide.

4. The cathode ray tube of claim 1, wherein the funnel has a deflection angle of about 125-13.5 degrees.

5. The cathode ray tube of claim 1, wherein the at least one region has a tensile stress of at least 1350 pounds per square inch.

6. The cathode ray tube of claim 1, wherein the second protective coating substantially covers the main body portion and extends from proximate the neck to the seal edge.

7. The cathode ray tube of claim 1, wherein the second protective coating is a silicone layer containing graphite or a poly-tetrafluoroethylene layer containing graphite.

8. A cathode ray tube having an envelope including a panel and a neck connected by a funnel, the funnel comprising:
a main body portion having a seal edge and a neck, the main body portion having a deflection angle of at least 125 degrees and at least one region with a tensile stress of at least 1350 pounds per square inch;
a first protective coating on an exterior surface of the main body portion, the first protective coating covering at least a portion of the at least one region, the first protective coating being of a composition and thickness to substantially reduce susceptibility of the at least one region to mechanical damage; and
a second protective coating on the exterior surface of the main body portion that covers at least a portion of the first protective coating, the second protective coating being of a composition and thickness to protect the funnel from moisture contact.

9. The cathode ray tube of claim 8, wherein the first protective coating is a silicate layer containing aluminum oxide, silicon carbide, titanium carbide, or boron carbide.

10. A method for making a cathode ray tube having an envelope including a panel and a neck connected by a funnel, comprising the steps of:
providing the funnel with a main body portion having at least one region with a higher tensile stress than other regions of the main body portion;
coating an external surface of the main body portion with a first protective coating such that the first protective coating covers at least a portion of the at least one region, the first protective coating being of a composition and thickness to substantially reduce susceptibility of the at least one region to mechanical damage;
attaching a seal edge of the main body portion to the panel;
mounting an electron gun in the neck;
evacuating and sealing the envelope; and
coating at least a portion of the first protective coating with a second protective coating, the second protective coating being of a composition and thickness to protect the funnel from moisture contact.

11. The method of claim 10, wherein the first protective coating is a silicate layer containing inorganic fillers.

12. The method of claim 10, further comprising forming the funnel to have a deflection angle of about 125-135 degrees.

13. The method of claim 10, wherein the at least one region has a tensile stress of at least 1350 pounds per square inch.

14. The method of claim 10, wherein the second protective coating is a poly-tetrafluoroethylene layer or silicone layer containing graphite.

15. A cathode ray tube having an envelope including a panel and a neck connected by a funnel, the funnel comprising:
a main body portion having a seal edge and a neck, the main body portion having at least one region with a higher tensile stress than other regions of the main body portion;
a first protective coating on an exterior surface of the main body portion, the first protective coating covering at least a portion of the at least one region; and
a second protective coating on the exterior surface of the main body portion that covers at least a portion of the first protective coating.

16. The cathode ray tube of claim 15, wherein the first protective coating is of a composition and thickness to substantially reduce susceptibility of the at least one region to mechanical damage.

17. The cathode ray tube of claim 15, wherein the second protective coating is of a composition and thickness to protect the funnel from moisture contact.

18. The cathode ray tube of claim 15, wherein the first protective coating is a silicate layer with an inorganic filler.

19. The cathode ray tube of claim 18, wherein the silicate layer is selected from the group consisting of a potassium silicate layer, a lithium silicate layer, and a sodium silicate layer.

20. The cathode ray tube of claim 18, wherein the inorganic filler is selected from the group consisting of an aluminum oxide, a silicon carbide, a boron carbide, and a titanium carbide.

21. The cathode ray tube of claim 15, wherein the funnel has a deflection angle of at least 125 degrees

22. A cathode ray tube having an envelope including a panel and a neck connected by a funnel, the funnel comprising:
a main body portion having a seal edge and a neck, the main body portion having at least one region with a higher tensile stress than other regions of the main body portion;
a protective coating on an exterior surface of the main body portion, the protective coating covering at least a portion of the at least one region, the protective coating being of a composition and thickness to substantially reduce susceptibility of the at least one region to mechanical damage.

23. The cathode ray tube of claim 22, wherein the protective coating is a silicate layer.

24. The cathode ray tube of claim 23, wherein the silicate layer is selected from the group consisting of a potassium silicate layer, a lithium silicate layer, and a sodium silicate layer.

25. The cathode ray tube of claim 23, wherein the silicate layer contains an inorganic filler.

26. The cathode ray tube of claim 25, wherein the inorganic filler is selected from the group consisting of an aluminum oxide, a silicon carbide, a boron carbide, and a titanium carbide.

27. The cathode ray tube of claim 22, wherein the main body portion has a deflection angle of at least 125 degrees.

28. The cathode ray tube of claim 22, wherein the at least one region has a tensile stress of at least 1350 pounds per square inch and the protective coating covers a majority of the at least one region.

29. A cathode ray tube having an envelope including a panel and a neck connected by a funnel, the neck containing therein an in-line electron gun oriented for transpose scanning of electron beams emitted from the in-line electron gun, the funnel comprising:
a main body portion having a seal edge and a neck, the main body portion having at least one region with a higher tensile stress than other regions of the main body portion;
a first protective coating on an exterior surface of the main body portion, the first protective coating covering at least a portion of the at least one region, the first protective coating being of a composition and thickness to substantially reduce susceptibility of the at least one region to mechanical damage; and
a second protective coating on the exterior surface of the main body portion that covers at least a portion of the first protective coating, the second protective coating being of a composition and thickness to protect the funnel from moisture contact.
